(19) United States
(12) Patent Application Publication
(10) Pub. No.: US 2005/0060704 A1
(43) Pub. Date: Mar. 17, 2005

(54) Managing processing within computing environments including initiation of virtual machines

(75) Inventors: Sandra R. Bulson, Hopewell Junction, NY (US); Visalakshi K. Ekanadham, Mohegan Lake, NY (US); Moon J. Kim, Wappingers Falls, NY (US); Colm Malone, Croton-on-Hudson, NY (US); Dikran S. Meliksetian, Danbury, CT (US); Scott F. Rohling, Golden, CO (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 10/667,163

(22) Filed: Sep. 17, 2003

(51) Int. Cl. G06F 9/455

(52) U.S. Cl. 718/1

(57) ABSTRACT

Virtual machines are provided on-demand. This on-demand service is beneficial in many situations, including, for instance, providing a virtual machine on-demand to process a request. The virtual machine provided to process the request is exclusive to the request. The on-demand virtual machine is automatically activated by another virtual machine, which has control over the on-demand virtual machine. The controlling virtual machine manages the start-up, provision of resources, and the shut-down of the on-demand virtual machine.

### TECHNICAL FIELD

This invention relates, in general, to facilitating processing within computing environments, and in particular, to managing various aspects of processing within a computing environment.

### BACKGROUND OF THE INVENTION

Isolation between tasks executing within a computing environment is important to avoid data corruption. In some systems, such as the S/390 systems offered by International Business Machines Corporation, Armonk, New York, a level of isolation and security is provided by the operating systems. Tasks are run as separate processes within an operating system, and the operating system controls the sharing of resources. Although the operating system offers a certain level of protection, intentional or accidental exposure or corruption of data of one task by another task is possible. Thus, a need exists for enhanced isolation between tasks.

Moreover, in computing environments, such as grid computing environments, interoperability among the different nodes of an environment is important to be able to share resources of those environments and to balance workloads. Although facilities, such as Sysplex and Workload Manager offered by International Business Machines Corporation, have been developed to facilitate workload management, those facilities are solutions for coupled systems that belong to a single family of processors. Thus, a need exists for a capability that facilitates workload management among heterogeneous systems.

### SUMMARY OF THE INVENTION

The shortcomings of the prior art are overcome and additional advantages are provided through the provision of a method of managing execution of requests. The method includes, for instance, obtaining by a node of a computing environment a request to be processed; and starting a virtual machine on the node to process the request, the virtual machine being exclusive to the request.

In a further aspect of the present invention, a method of managing initiation of virtual machines of a computing environment is provided. The method includes, for instance, determining by one virtual machine of a computing environment that another virtual machine is to be initiated; and initiating, by the one virtual machine, the another virtual machine.

In yet a further aspect of the present invention, a method of providing an on-demand infrastructure is provided. The method includes, for instance, deploying logic on at least one node of a computing environment to automatically provide a virtual machine on-demand.

System and computer program products corresponding to the above-summarized methods are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one embodiment of a computing environment incorporating and using one or more aspects of the present invention;

FIG. 2a depicts one embodiment of several components of the computing environment of FIG. 1 used in accordance with an aspect of the present invention;

FIG. 2b depicts one embodiment of a coupling of a plurality of components of FIG. 2a, in accordance with an aspect of the present invention;

FIG. 3 depicts one embodiment of the logic associated with processing a request on a selected node of the computing environment, in accordance with an aspect of the present invention;

FIG. 4 depicts one embodiment of the logic associated with starting a virtual machine to execute a request, in accordance with an aspect of the present invention;

FIG. 5 depicts one embodiment of the logic associated with shutting down the virtual machine, in accordance with an aspect of the present invention; and

FIG. 6 depicts one embodiment of a node of FIG. 1 partitioned into a plurality of partitions, in accordance with an aspect of the present invention.

### BEST MODE FOR CARRYING OUT THE INVENTION

In accordance with an aspect of the present invention, a request obtained by a node of a computing environment is processed by a virtual machine of that node, and the virtual machine is exclusive to that request. In one example, the starting of the virtual machine is initiated or controlled by another virtual machine of the node. Subsequent to completing the request, the virtual machine exclusive to the request is sanitized and terminated.

By utilizing a virtual machine that is exclusive to the request, isolation between requests is provided. Further, the use of virtual machines to process requests facilitates interoperability among the various nodes of a computing environment, including a grid computing environment. In one embodiment, a service determines which node of the plurality of nodes is available to process a request and the request is sent to that node for processing. A manager virtual machine on that node then initiates a job virtual machine to process the request.

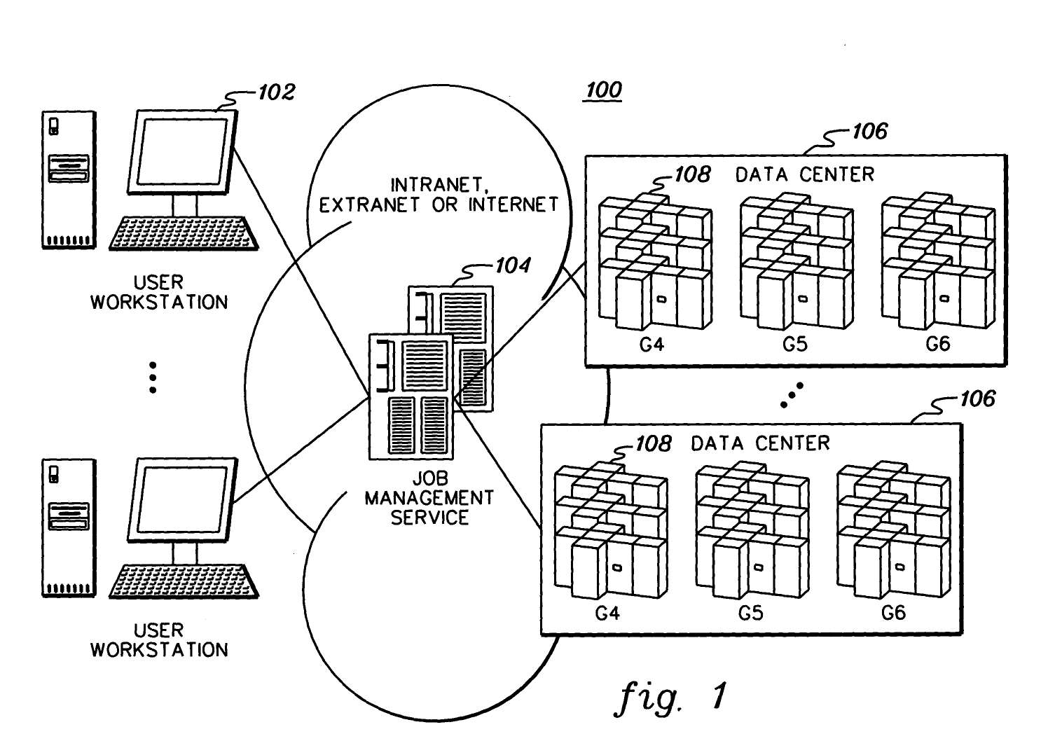

One embodiment of a computing environment incorporating and using one or more aspects of the present invention is described with reference to FIG. 1. In this particular example, the computing environment is a grid environment. A grid environment is one in which the infrastructure is defined as flexible and secure, and provides coordinated resource sharing among a dynamic collection of individuals, institutions and resources. It is distinguished from conventional distributed (enterprise) computing by its focus on large-scale resource sharing, innovative applications, and, in some cases, high-performance orientation. The collection of individuals and institutions that contribute resources to a particular grid and/or use the resources in that grid is referred to as a virtual organization and represent a new approach to computing and problem solving based on collaboration among multiple disciplines in computation and data-rich environments.

Computing environment 100 includes, for instance, a plurality of user workstations 102 (e.g., laptops, notebooks, such as ThinkPads, personal computers, RS/6000s, etc.) coupled to a job management service 104 via, for instance, the internet, extranet or intranet. Job management service 104 includes, for instance, a Web application (or other process) to be executed on a Web application server (or node), such as WebSphere offered by International Business Machines Corporation, or distributed across a plurality of servers or nodes. It has the responsibility for accepting user requests and passing the requests to the appropriate nodes of the environment. As one example, a user interacts with the job management service through a client application, such as a Web Browser or a standalone application. There are various products that include a job management service including, for instance, LSF offered by Platform (www.platform.com), and Maui, an open source scheduler available at http://www.supercluster.org.

Job management service 104 is further coupled via the internet, extranet or intranet to one or more data centers 106. Each data center includes, for instance, one or more nodes 108. As one example, a node is a mainframe computer based on the S/390 Architecture or z/Architecture offered by International Business Machines Corporation, Armonk, N.Y. One example of the z/Architecture is described in an IBM® publication entitled,“z/Architecture Principles of Operation,” IBM Publication No. SA22-7832-00, December 2000, which is hereby incorporated herein by reference in its entirety. (IBM® is a registered trademark of International Business Machines Corporation, Armonk, N.Y., USA. Other names used herein may be registered trademarks, trademarks, or product names of International Business Machines Corporation or other companies.)

The nodes of the environment may be homogeneous or heterogeneous nodes. In the example depicted in FIG. 1, each node of a data center is of a different generation (e.g., Generation 4 (G4), Generation 5 (G5), Generation 6 (G6)). However, this is only one example. As another example, all of the nodes can be of the same generation. As yet other examples, combinations of homogeneous and heterogeneous nodes are provided. Further, one or more of the nodes can be of different families. Many other possibilities exist.

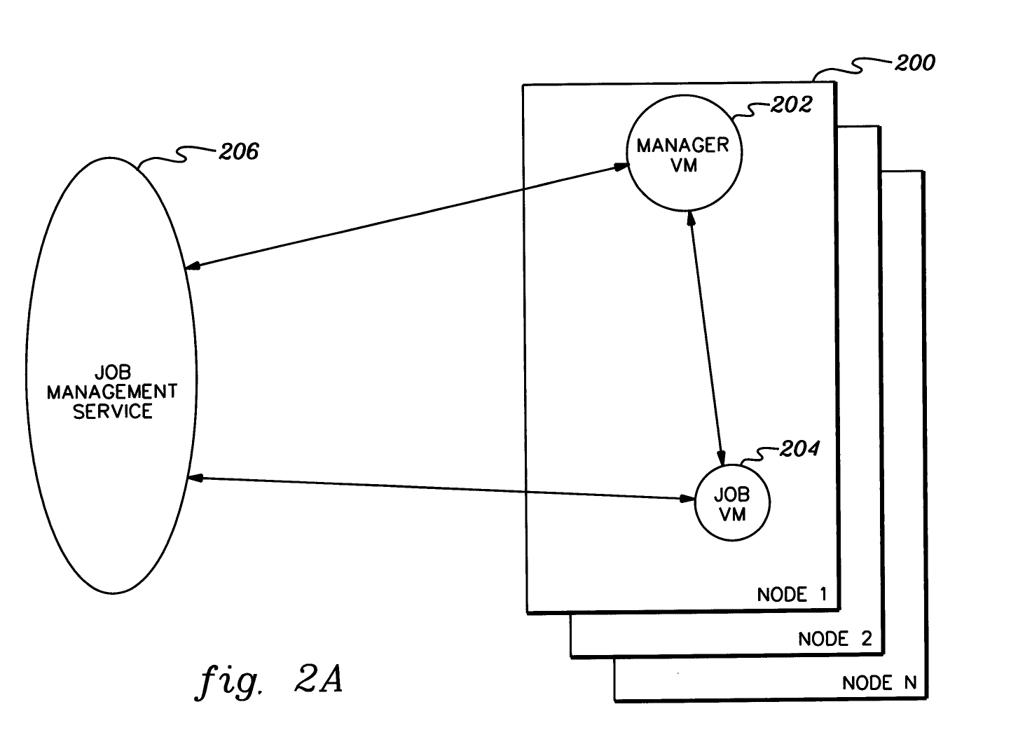

Further details regarding a node and the interaction of the node with job management service 104 are described with reference to FIG. 2a. As shown in FIG. 2a, a node 200 includes a plurality of virtual machines (e.g., 202, 204). Each virtual machine is capable of functioning as a separate system. That is, each virtual machine can be independently reset, host an operating system, such as Linux, and operate with different programs. An operating system or application program running in a virtual machine appears to have access to a full and complete system, although only a portion of it is typically available. One or more aspects of a virtual machine are described in an IBM® publication, entitled“z/VM: Running Guest Operating Systems,” IBM Publication No. SC24-5997-02, October 2001; and an IBM® publication, entitled “z/VM: General Information Manual,” IBM Publication No. GC24-5991-04, October 2001, each of which is hereby incorporated herein by reference in its entirety.

In one embodiment, at least one of the virtual machines is a manager virtual machine 202 and at least one other virtual machine is referred to as a job virtual machine 204. The manager virtual machine is coupled to the job virtual machine and has the responsibility of managing the job virtual machine which is used to process a particular request. Each job virtual machine is exclusive to a request and the starting and terminating of the job virtual machine is controlled by the manager virtual machine.

The manager virtual machine obtains (e.g., receives, is forwarded, retrieves, etc.) a request to be processed from a job management service 206 coupled to manager virtual machine 202 and job virtual machine 204. The manager virtual machine communicates with the job management service and responds to queries from the service. In one example, this communication is through grid middleware, such as the Globus Toolkit available from the Globus Project at www.globus.org or the IBM Grid Toolbox available at www.alphaworks.ibm.com. As one example, the information obtained from the queries is used to determine whether the request is to be sent to the node of the manager virtual machine. If the node can accommodate the request, the request is sent to the manager virtual machine, which controls the initiation of a job virtual machine to process the request. During processing of the request, the job virtual machine communicates directly with the job management service to provide status and/or results.

In one example, the manager virtual machine communicates with a job virtual machine via a communications service, which uses a communications protocol, such as TCP/IP, hipersockets, etc. For example, as shown in FIG. 2b, manager virtual machine 202 is coupled to job virtual machine 204 via a communications service 210. In this example, the communications service includes a host virtual machine on the node executing TCP/IP. That is, the node includes a host operating system, such as z/VM offered by International Business Machines Corporation, and the manager virtual machine and the job virtual machine are guests of the host. The communications service receives instructions from the manager virtual machine and provides appropriate commands to the job virtual machine, as described in further detail below.

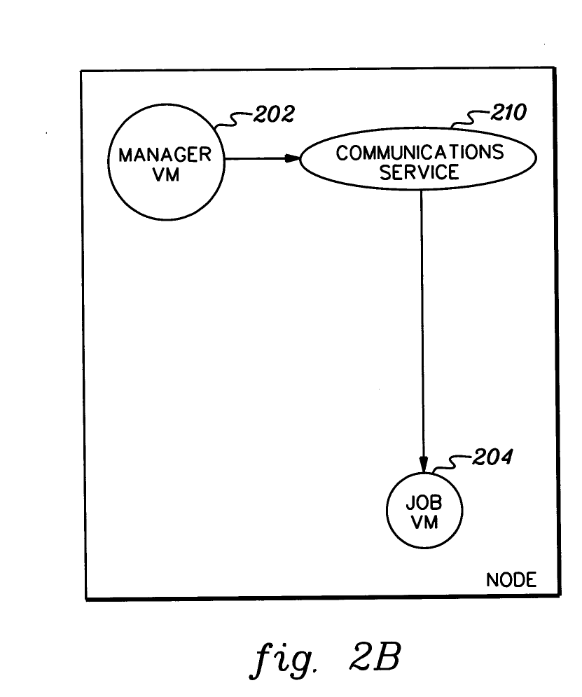

Interaction between the manager virtual machine, the job virtual machine and the job management service is described in further detail with reference to FIG. 3, in which one embodiment of the logic associated with processing a request is described. In one example, interactions between a user 300, a job management service 302, a manager virtual machine 304 and a job virtual machine 306 are described. Initially, in one example, user 300 submits a request to job management service 302, STEP 308. The request is, for example, a job request which includes, for instance, an executable, data, and resource requirements, such as a needed amount of one or more of filesystem space, virtual processors, virtual storage, etc.

In response to receiving the request (or prior to the request), job management service 302 sends a query to one or more manager virtual machines 304 to determine the resource availability on the nodes managed by the manager virtual machines, STEP 310. The manager virtual machine determines its available resources, via, for instance, query commands, and sends a description of those resources to job management service 302, STEP 312. In the example in which the job management service sends queries to a plurality of manager virtual machines, the job management service makes a decision based on, for instance, resource availability as to which node the request is to be submitted. The job management service then submits the request to a selected manager virtual machine, STEP 314.

In response to receiving the job request, the manager virtual machine activates a job virtual machine, STEP 316, and allocates the necessary and/or desired resources for the request, STEP 318. This virtual machine is exclusive to the request, and in one example, it is predefined such that it can be activated without performing a defining action. While one or more job virtual machines are predefined in this embodiment to minimize time in activating a virtual machine, in other embodiments, one or more of the job virtual machines are not predefined, but instead, are defined when needed.

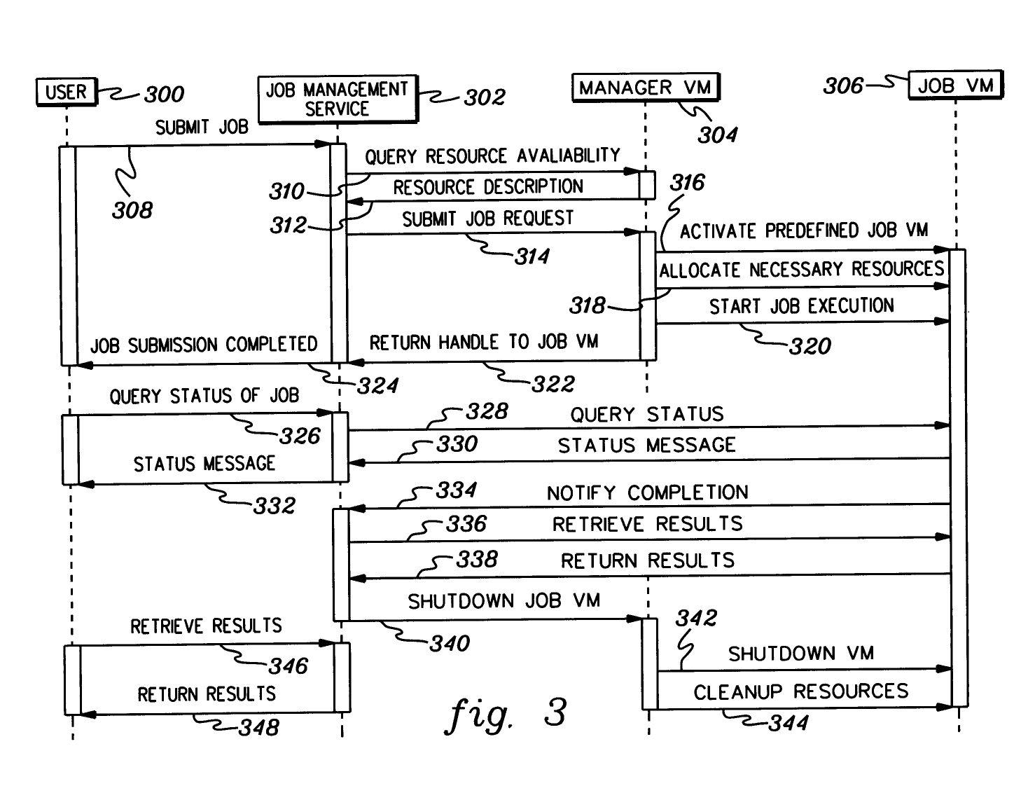

One embodiment of the logic associated with activating a virtual machine and allocating the resources is described with reference to FIG. 4. Initially, the manager virtual machine obtains a request to be processed, STEP 400. This request includes a description of the needed and/or desired resources to process the request. The manager virtual machine then initiates the starting of a job virtual machine to process the request, STEP 402. As one example, this includes sending a startup command to the communications service coupled to the manager virtual machine. One example of a startup command is as follows:

rexec-1 vm_userid-p vm_password vm_hostname start target_userid[-mem_size ][-proc_num].

This command executes a start script on the communications service, passing it the specified arguments. The first argument specifies a user id of the target job virtual machine. The subsequent arguments are optional and are used, for instance, to indicate that additional resources are needed to process the request. That is, the manager virtual machine checks the resources defined for the job virtual machine to ensure that there are sufficient resources to process the request. If additional resources are desired, then those resources are requested in this command. For example, -mem specifies the memory size to be allocated, and -proc specifies the number of virtual processors to be allocated.

The start script running on the communications service, as a result of the start command, autologs the specified user id, issues the appropriate commands to add resources, if needed, and IPLs the job virtual machine. For instance, if it is indicated in the rexec command that resources are needed, then the communications service issues the appropriate commands to add those resources to the job virtual machine, STEP 404. As an example, if virtual storage is to be added to the job virtual machine, then a DIRMAINT command with a storage operand, such as DIRM FOR userid STORAGE 1G, is provided. As a further example, if a virtual machine desires the maximum virtual storage size available to it, then a DIRMAINT command with a max store operation, such as DIRM FOR userid MAXSTOR 2048M, is provided. As yet a further example, should a virtual processor be added, a DIRMAINT command with a CPU operand, such as DIRM FOR userid CPU cpuaddr, is provided.

Other configurable resources can be added in a similar manner. For instance, filesystem space is added by issuing a DIRMAINT command with an AMDISK operand, such as DIRM FOR userid AMDISK vaddr xxx. In this case, a RACF command is also used to define the disk to RACF. Such a command includes, for instance, RAC RDEFINE VMMDISK userid.vaddr OWNER(userid). Examples of DIRMAINT and RACF commands are described in an IBM Publication SC24-60025-03, entitled “z/VM—Directory Maintenance Facility Function Level 410 Command Reference,” Version 4, Release 3.0, October 2002; and an IBM Publication SC28-0733-16, entitled “RACF V1R10 Command Language Reference,” Version 1, Release 10, August 1997, each of which is hereby incorporated herein by reference in its entirety.

Although examples of-resources to be added to a virtual machine are provided herein, many other possibilities exist. The start command can be revised to include arguments for any configurable resources. The shut down command, described below, can also be similarly revised.

In addition to adding the resources to the job virtual machine, the job virtual machine is IPL-ed, STEP 406. In one example, this includes reading a named file that is maintained for the job virtual machine instance, autologging the job virtual machine instance based on the information and booting up any disks relating to that instance. This completes the start-up of the job virtual machine.

Returning to FIG. 3, subsequent to activating the job virtual machine and allocating the resources, execution of the request is started on the job virtual machine, STEP 320. Further, the manager virtual machine returns a handle (e.g., an identifier) of the job virtual machine to the job management service, so that the job management service can communicate directly with the job virtual machine, STEP 322. In one example, this communication is through grid middleware, such as the Globus Toolkit available from the Globus Project at www.globus.org or the IBM Grid Toolbox available at www.alphaworks.ibm.com. As one example, the job management service notifies the user that job submission is complete, STEP 324.

At some time during processing, the user may desire to obtain status of the request. Thus, the user sends a query request to the job management service, STEP 326, which, in turn, sends a status query request to the job virtual machine, STEP 328. Subsequent to receiving the status query request, the job virtual machine sends a status message to the job management service, STEP 330. The status message is then forwarded from the job management service to the user, STEP 332.

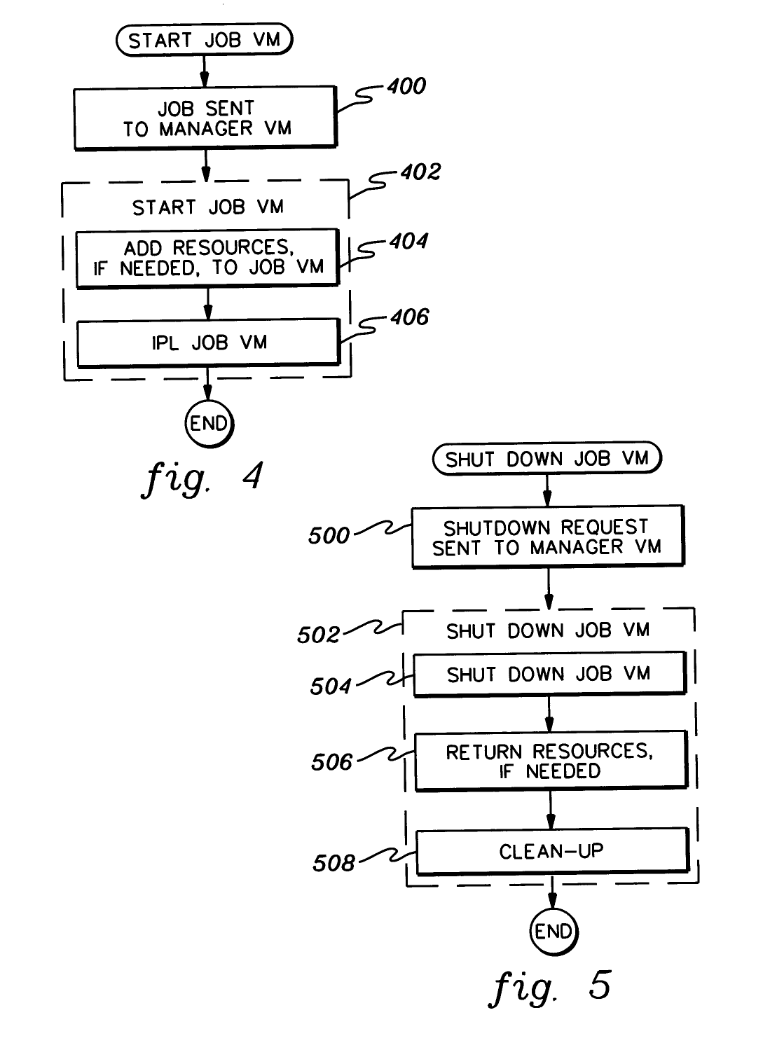

When the job completes, the job virtual machine sends a completion notification to the job management service, STEP 334. The job management service sends a message to the job virtual machine requesting the results, STEP 336, and the job virtual machine returns the results, STEP 338. Job management service 302 then requests shutdown of the job virtual machine, STEP 340. For example, it sends a shutdown request to the manager virtual machine, which controls the shut down of the job virtual machine, STEP 342, including the clean up of resources used by the job virtual machine, STEP 344. Further details associated with shutting down the job virtual machine are described with reference to FIG. 5.

Referring to FIG. 5, one embodiment of the logic associated with shutting down the job virtual machine via the manager virtual machine is described. The manager virtual machine obtains a request to shut down the job virtual machine, STEP 500. Thus, the manager virtual machine proceeds with shut down, STEP 502. In one example, this includes sending a command from the manager virtual machine to the communications service. One example of a shut down command is as follows:

rexec-1 vm_userid -p vm_password vm_hostname shutdown target_userid.

In response to receiving the command, the communications service sends a shutdown command, such as a LINUX shutdown command, to the job virtual machine to shut down the job virtual machine, STEP 504. Additionally, any additional resources allocated to the job virtual machine are returned, STEP 506. In one example, this is accomplished by issuing the appropriate DIRMAINT/RACF commands which depend on the type of resources to be returned. For instance, if the resource to be returned is virtual storage, then a DIRM FOR userid STORAGE 512M command, for instance, is issued to return the virtual storage level to its original amount. Similarly, if virtual processors are to be returned, then a DIRM FOR userid CPU cpuaddr DELETE command is issued to delete a virtual processor. As a further example, to delete filesystem space, a DIRM FOR userid DMDISK vaddr command is issued. Also, a RACF command, such as RAC RDELETE VMMDISK userid.vaddr command is also issued.

Additionally, clean-up of the job virtual machine is performed, STEP 508. This clean-up includes, for instance, removing old files and placing the job virtual machine back to its original image. In one example, a DDR clone operation may be used to perform the clean-up. One example of this operation is described in an IBM Publication SC24-6008-03, entitled “z/VM—CP Command and Utility Reference,” Version 4, Release 3.0, May 2002, which is hereby incorporated herein by reference in its entirety.

Returning to FIG. 3, at a user-selected point in time, the user sends a request to the job management service to retrieve the results, STEP 346, and the job management service returns the results to the user, STEP 348. This concludes processing of the request.

Described in detail above is a capability that enables each request to be processed by a separate virtual machine having its own operating system. This advantageously provides isolation between the requests being processed. Although an example of a request is provided herein (e.g., a job request), one or more aspects of the present invention are applicable to other types of requests. Further, a job request may include additional, less or different information from that described herein.

Also described herein is a service that communicates with the various manager virtual machines to determine which node of the environment is best suited to execute a particular request. The nodes in the environment can be homogeneous nodes, heterogeneous nodes, or a combination thereof, which are coupled together in, for instance, a grid computing environment.

Although in one embodiment a grid computing environment is described, one or more aspects of the present invention are applicable to other environments, including non-grid environments. Moreover, many variations to the environment described herein are possible without departing from the spirit of one or more aspects of the present invention. For example, the nodes can be other than mainframes and/or there can be a mixture of mainframe and other classes of nodes. As other examples, the user workstations and server for the job management service can be different from those described herein. Further, architectures other than S/390 or the z/Architecture are capable of using one or more aspects of the present invention. For example, one or more aspects of the present invention apply to the Plug Compatible Machines (PCM) from Hitachi, as well as systems of other companies. Other examples are also possible. Further, operating systems other than Linux and z/VM may be used.

As yet another example, the user can be replaced by an automated service or program. Further, a single job may include multiple jobs that run simultaneously on multiple nodes. This is accomplished similarly to that described above. For instance, the job management service contacts a plurality of manager virtual machines and has those machines manage the plurality of requests. Many other variations also exist.

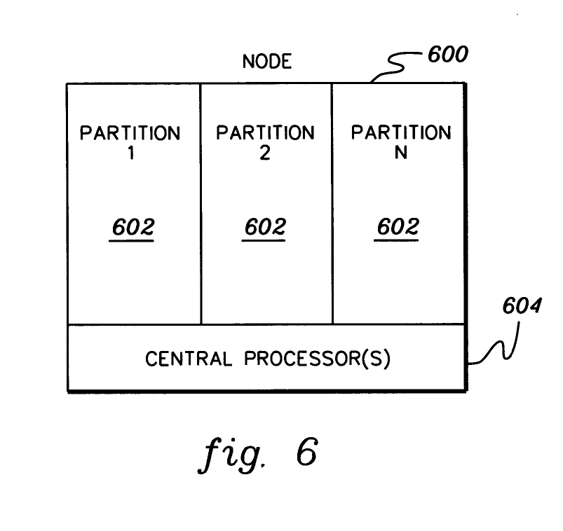

As another example, the environment may include one or more nodes that are partitioned. For instance, as shown in FIG. 6, at least one node 600 of the environment is partitioned into a plurality of zones or partitions via, for instance, logical partitioning. Each logical partition functions as a separate system having, for instance, a resident or host operating system and one or more applications. Further, each logical partition has one or more logical processors, each of which represents all or a share of a physical processor 604 allocated to the partition. The logical processors of a particular partition may be either dedicated to the partition, so that the underlying processor resource is reserved for that partition, or shared with another partition, so that the underlying processor resource is potentially available to another partition. Examples of logical partitioning are described in Guyette et al., U.S. Pat. No. 4,564,903, entitled “Partitioned Multiprocessor Programming System,” issued on Jan. 14, 1986; Bean et al., U.S. Pat. No. 4,843,541, entitled “Logical Resource Partitioning Of A Data Processing System,” issued on Jun. 27, 1989; and Kubala, U.S. Pat. No. 5,564,040, entitled “Method And Apparatus For Providing A Server Function In A Logically Partitioned Hardware Machine,” issued on Oct. 08, 1996, each of which is hereby incorporated herein by reference in its entirety. In this environment, each partition (or a subset thereof) includes a manager virtual machine that is responsible for spawning one or more job virtual machines for requests to be processed within that logical partition.

Despite the type of environment, advantageously, one or more aspects of the present invention enable the harnessing of unutilized compute power, which provides immediate economic benefits to an organization that has a large installed base of nodes. Typically, users on a system only use part of the maximum capacity of the system (e.g., on the order of 60%), so there is room for additional workload. This unutilized capacity or cycles is referred to as white space. In accordance with an aspect of the present invention, this white space can be used by adding more users or virtual machines to process additional requests. This reduces the amount of wasted resources due to the underutilization of those resources. As one example, the unutilized processing power of mainframe computers is harnessed and made available for grid computing. This is accomplished by coupling those nodes through grid technologies and by enhancing the grid technologies to take advantage of the features of the nodes (e.g., mainframes).

As a further aspect, workload management is provided by enabling the migration of one or more jobs from one node (or LPAR) to another node (or LPAR), when resources are not available on the current node (or LPAR) to sufficiently process the one or more jobs. Further, resources may be added or removed from a node (or LPAR) based on workload and/or utilization of other nodes (or LPARs). Various workload management techniques are described in, for instance, U.S. Pat. No. 5,473,773, Aman et al., entitled “Apparatus And Method For Managing A Data Processing System Workload According to Two Or More Distinct Processing Goals,” issued Dec. 5, 1995; and U.S. Pat. No. 5,675,739, Eilert et al., entitled “Apparatus And Method For Managing A Distributed Data Processing System Workload According To A Plurality Of Distinct Processing Goal Types,” issued Oct. 7, 1997, each of which is hereby incorporated herein by reference in its entirety.

In yet a further aspect, a capability is provided for on-demand provision of virtual machines, in which an on-demand virtual machine is automatically started and configured. In the embodiment described herein, this on-demand service is used to process job requests; however, this is only one example. The on-demand service can be used in processing many types of requests, including, for instance, requests for machine resources. The on-demand provision of virtual machines can be included and/or utilized in many different scenarios. For example, the on-demand capability can be used to allow customers to lease or rent the use of a virtual machine for a period of time. This is useful, for example, in an educational setting, in which a course is given on-line. Each student taking the course can have its own virtual machine for a certain period of time on certain days. Many other embodiments are also possible.

In one example, the on-demand virtual machine is controlled by another virtual machine referred to as a manager virtual machine. The manager virtual machine controls the start, allocation of resources and shut down of the on-demand virtual machine.

In yet a further aspect of the present invention, an on-demand service is provided in which logic to automatically provide a virtual machine on-demand is deployed on one or more nodes of a computing environment. To deploy the logic, the logic (e.g., code) may be placed in a node accessible to others (e.g., users, third parties, customers, etc.) for retrieval; sent to others via, for instance, e-mail or other mechanisms; placed on a storage medium (e.g., disk, CD, etc.) and mailed; sent directly to directories of others; and/or loaded on a node for use, as examples.

The present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

1. A method of managing execution of requests of a computing environment, said method comprising:
obtaining by a node of the computing environment a request to be processed; and
starting a virtual machine on the node to process the request, said virtual machine being exclusive to the request.

2. The method of claim 1, wherein the starting is managed at least in part by another virtual machine of the node.

3. The method of claim 1, wherein said obtaining comprises receiving the request by another virtual machine of the node, and wherein the starting comprises starting the virtual machine by the another virtual machine.

4. The method of claim 3, wherein the receiving the request comprises receiving the request from a job management service coupled to the another virtual machine.

5. The method of claim 1, wherein the starting comprises providing one or more resources to the virtual machine to process the request.

6. The method of claim 1, further comprising shutting down the virtual machine, in response to completing the request.

7. The method of claim 6, wherein the shutting down comprises returning one or more resources provided to the virtual machine.

8. The method of claim 6, wherein said shutting down is managed at least in part by another virtual machine of the node.

9. The method of claim 8, wherein said shutting down comprises using by the another virtual machine a communications service to shut down the virtual machine.

10. The method of claim 1, wherein said obtaining comprises obtaining by another virtual machine of the node the request to be processed, and wherein the starting comprises:
providing by the another virtual machine to a communications service coupled to said another virtual machine and said virtual machine a start indication indicating that the virtual machine is to be started; and
using the communications service to start the virtual machine.

11. The method of claim 1, further comprising:
determining which node of a plurality of nodes is available to process the request; and
sending the request to the node determined to be available.

12. The method of claim 11, wherein said determining comprises obtaining from one or more other virtual machines of one or more nodes of the plurality of nodes information to be used in the determining.

13. The method of claim 11, wherein said plurality of nodes include at least one node that is heterogeneous to another node.

14. The method of claim 13, wherein the one node is of at least one of a different family and different generation than the another node.

15. The method of claim 1, further comprising processing the request by the virtual machine.

16. The method of claim 15, further comprising providing from said virtual machine to a job management service information regarding the request being processed.

17. The method of claim 1, wherein said virtual machine is a sanitized virtual machine.

18. A method of managing initiation of virtual machines of a computing environment, said method comprising:
determining by one virtual machine of a computing environment that another virtual machine is to be initiated; and
initiating, by the one virtual machine, the another virtual machine.

19. The method of claim 18, wherein the determining is in response to receiving by the one virtual machine a request to be processed.

20. The method of claim 19, wherein the request is for utilization of machine resources.

21. The method of claim 18, wherein said initiating comprises using by the one virtual machine a communications service in initiating the another virtual machine.

22. A method of providing an on-demand infrastructure, said method comprising:
deploying logic on at least one node of a computing environment to automatically provide a virtual machine on-demand.

23. A system of managing execution of requests of a computing environment, said system comprising:
means for obtaining by a node of the computing environment a request to be processed; and
means for starting a virtual machine on the node to process the request, said virtual machine being exclusive to the request.

24. The system of claim 23, wherein said means for obtaining comprises means for receiving the request by another virtual machine of the node, and wherein the means for starting comprises means for starting the virtual machine by the another virtual machine.

25. The system of claim 23, wherein the means for starting comprises means for providing one or more resources to the virtual machine to process the request.

26. The system of claim 23, further comprising means for shutting down the virtual machine, in response to completing the request.

27. The system of claim 26, wherein the shutting down is managed at least in part by another virtual machine of the node.

28. The system of claim 23, wherein said means for obtaining comprises means for obtaining by another virtual machine of the node the request to be processed, and wherein the means for starting comprises:
means for providing by the another virtual machine to a communications service coupled to said another virtual machine and said virtual machine a start indication indicating that the virtual machine is to be started; and
means for using the communications service to start the virtual machine.

29. The system of claim 23, further comprising:
means for determining which node of a plurality of nodes is available to process the request; and
means for sending the request to the node determined to be available.

30. The system of claim 29, wherein said means for determining comprises means for obtaining from one or more other virtual machines of one or more nodes of the plurality of nodes information to be used in the determining.

31. The system of claim 23, further comprising:
means for processing the request by the virtual machine; and
means for providing from said virtual machine to a job management service information regarding the request being processed.

32. A system of managing initiation of virtual machines of a computing environment, said system comprising:
means for determining by one virtual machine of a computing environment that another virtual machine is to be initiated; and
means for initiating, by the one virtual machine, the another virtual machine.

33. The system of claim 32, wherein the determining is in response to receiving by the one virtual machine a request to be processed.

34. The system of claim 33, wherein the request is for utilization of machine resources.

35. The system of claim 32, wherein said means for initiating comprises means for using by the one virtual machine a communications service in initiating the another virtual machine.

36. A system of managing execution of requests of a computing environment, said system comprising:
a node of the computing environment to obtain a request to be processed; and
a virtual machine on the node to process the request, said virtual machine being exclusive to the request.

37. A system of managing initiation of virtual machines of a computing environment, said system comprising:
one virtual machine of a computing environment to determine that another virtual machine is to be initiated; and
the another virtual machine initiated by the one virtual machine.

38. An article of manufacture comprising:
at least one computer usable medium having computer readable program code logic to manage execution of requests of a computing environment, the computer readable program code logic comprising:
obtain logic to obtain by a node of the computing environment a request to be processed; and
start logic to start a virtual machine on the node to process the request, said virtual machine being exclusive to the request.

39. The article of manufacture of claim 38, wherein said obtain logic comprises receive logic to receive the request by another virtual machine of the node, and wherein the start logic comprises logic to start the virtual machine by the another virtual machine.

40. The article of manufacture of claim 38, wherein the start logic comprises provide logic to provide one or more resources to the virtual machine to process the request.

41. The article of manufacture of claim 38, further comprising shut down logic to shut down the virtual machine, in response to completing the request.

42. The article of manufacture of claim 41, wherein the shut down is managed at least in part by another virtual machine of the node.

43. The article of manufacture of claim 38, wherein said obtain logic comprises logic to obtain by another virtual machine of the node the request to be processed, and wherein the start logic comprises:
provide logic to provide by the another virtual machine to a communications service coupled to said another virtual machine and said virtual machine a start indication indicating that the virtual machine is to be started; and
use logic to use the communications service to start the virtual machine.

44. The article of manufacture of claim 38, further comprising:
determine logic to determine which node of a plurality of nodes is available to process the request; and
send logic to send the request to the node determined to be available.

45. The article of manufacture of claim 44, wherein said determine logic comprises obtain logic to obtain from one or more other virtual machines of one or more nodes of the plurality of nodes information to be used in the determining.

46. The article of manufacture of claim 38, further comprising:
process logic to process the request by the virtual machine; and
provide logic to provide from said virtual machine to a job management service information regarding the request being processed.

47. An article of manufacture comprising:
at least one computer usable medium having computer readable program code logic to manage initiation of virtual machines of a computing environment, the computer readable program code logic comprising:
determine logic to determine by one virtual machine of a computing environment that another virtual machine is to be initiated; and
initiate logic to initiate, by the one virtual machine, the another virtual machine.

48. The article of manufacture of claim 47, wherein the determining is in response to receiving by the one virtual machine a request to be processed.

49. The article of manufacture of claim 48, wherein the request is for utilization of machine resources.

50. The article of manufacture of claim 47, wherein said initiate logic comprises use logic to use by the one virtual machine a communications service in initiating the another virtual machine.
